(19) United States
(12) Patent Application Publication
(10) Pub. No.: US 2017/0366689 A1
(43) Pub. Date: Dec. 21, 2017

(54) SYSTEM AND METHOD FOR CONVEYING MULTIFUNCTION DEVICE STATUS INFORMATION USING LIGHT PROJECTION ON A MULTIFUNCTION DEVICE

(71) Applicant: Xerox Corporation, Norwalk, CT (US)

(72) Inventors: Joseph R. Broughton, Hertfordshire (GB); Ashokkumar Govindbhai Mistry, Hertfordshire (GB); Darren Lead, Hertfordshire (GB); Nathan Batchelor, Luton (GB)

(21) Appl. No.: 15/186,680

(22) Filed: Jun. 20, 2016

(51) Int. Cl. H04N 1/00

(52) U.S. Cl. CPC H04N 1/00477; H04N 1/00488; H04N 1/00076; H04N 2201/0094

(57) ABSTRACT

A system for providing multifunction device (MFD) status information to a user includes an MFD and a light projection unit. The MFD may include a print engine and one or more status monitors. The light projection unit may include a light projecting module, and a processor for receiving information corresponding to a current machine state of the MFD from the status monitors of the MFD. The processor may identify an area of the MFD that corresponds to the current machine state, and identify a projected light pattern associated with the current machine state. The projected light pattern includes a visual pattern created using projected light. The processor may instruct the light projecting module to project the identified projected light pattern proximate to the identified area of the MFD.

### BACKGROUND

In the competitive consumer market for multifunction devices (MFDs) and other types of printing devices, it is of particular importance that a device be user-friendly. The ability of a device to provide customizable features and functions can drastically affect customer satisfaction. One aspect of a “user-friendly” print device is its effectiveness in communicating status and configuration information to the user.

Commercially available printing devices typically include one or more monochromatic indicator lights configured to visually indicate to the user the current status or machine state of the printing device. Printing devices may further include indicator lights (such as light emitting diodes (LEDs)) that are multi-color to enhance the indication function of the indicator light. A problem associated with existing indicator lights is limited viewing and/or monitoring on the device. For example, the LED indicator lights are typically provided on top of and/or at the front of a print device (for example on a user interface (UI)). While a conventional indicator light mounting arrangement may be able to provide desired information about the status of the print device, the indicators often are not visible from different viewing angles and/or distances.

Additionally, a status indicator message provided using LED indicator lights in a UI is typically spatially disconnected from the actual area of interest (such as an output area, a fault area, or the like), and the user must take the time to view and/or read the status indicator message.

This document describes devices and methods that are intended to address issues discussed above and/or other issues.

### SUMMARY

A system (and method) for providing multifunction device (MFD) status information to a user includes an MFD and a light projection unit. The MFD may include a print engine and one or more status monitors. The light projection unit may include a light projecting module, a processor in communication with the light projecting module, and a computer-readable medium containing programming instructions. The system may receive information corresponding to a current machine state of the MFD from the status monitors of the MFD. The processor may identify an area of the MFD that corresponds to the current machine state, and a projected light pattern associated with the current machine state. The projected light pattern may include a visual pattern created using projected light. The processor may instruct the light projecting module to project the identified projected light pattern proximate to the identified area of the MFD.

In an embodiment, the light projecting module may include one or more light emission devices, an optical component, and a control unit. The control unit may be configured to receive the projected light pattern associated with the identified machine state from the processor, and generate commands to cause the one or more light emission devices to emit the visual pattern. In some embodiments, the system may adjust a direction of projection of the light projecting module, to project the identified projected light pattern proximate to the identified area of the MFD, by turning the optical component and/or turning one or more of the light emission devices on or off. The optical component may include an optical lens, an optical panel, an optical channel, a prism, and/or a reflective surface.

In at least one embodiment, a characteristic of the visual pattern may dynamically change to convey real-time information about the status of the identified machine state. The characteristic may be selected from the following: a size of the visual pattern, a shape of the visual pattern, an intensity of the visual pattern, a brightness of the visual pattern, or a combination thereof.

In an embodiment, the system may receive the information corresponding to the current machine state from the MFD continuously, at fixed time intervals, in response to a change in a machine state of the MFD, and/or in response to a request sent from the light projection unit to the MFD.

In some embodiments, the system may identify the area of the MFD that corresponds to the current machine state as an area that provides additional information relating to the current machine state. The identified area may be selected from the following: a document processing job output tray, a document processing job input tray, an ink cartridge, or a combination thereof.

In an embodiment, the projected light pattern may include a blinking light pattern, a solid light pattern in one or more light colors, a growing bar shape light pattern, a growing ring shape light pattern, a pattern created by varying an intensity of projected light, text, symbols, or a combination thereof.

In an example embodiment, the current machine state may correspond to an output of a document processing job, and the identified area may be an output tray of the MFD. The system may identify the identified projected light pattern such that it conveys information regarding an identification of the output tray to which the output of the document processing job will be delivered, a status of the document processing job, completion of the document processing job, or a combination thereof.

In an alternate embodiment, the current machine state may correspond to an input of a document processing job, and the identified area may be an input tray of the MFD. The system may identify the identified projected light pattern such that it conveys information regarding an identification of the input tray from which paper is fed for the document processing job, needs more paper, a paper jam, or a mis-feed jam, or a combination thereof.

### BRIEF DESCRIPTION OF THE DRAWINGS

FIG. 1 illustrates an example system for conveying device status information using projected light, according to an embodiment.

FIG. 2 illustrates a back view of the light projection unit of FIG. 1, according to an embodiment.

FIG. 3 illustrates an example block diagram of a light projection unit, according to one embodiment.

FIG. 4 illustrates an example diagram of a light projecting module, according to one embodiment.

FIG. 5 is a flowchart that illustrates an example method for conveying device status information using projected light, according to one embodiment.

FIG. 6 depicts various embodiments of one or more electronic devices for implementing the various methods and processes described herein.

### DETAILED DESCRIPTION

This disclosure is not limited to the particular systems, methodologies or protocols described, as these may vary. The terminology used in this description is for the purpose of describing the particular versions or embodiments only, and is not intended to limit the scope.

As used in this document, any word in singular form, along with the singular forms “a,” “an” and “the,” include the plural reference unless the context clearly dictates otherwise. Unless defined otherwise, all technical and scientific terms used herein have the same meanings as commonly understood by one of ordinary skill in the art. All publications mentioned in this document are incorporated by reference. Nothing in this document is to be construed as an admission that the embodiments described in this document are not entitled to antedate such disclosure by virtue of prior invention. As used herein, the term “comprising” means “including, but not limited to.”

A “print device” refers to a device that includes a print engine for printing documents. The print device may also include a processor that can process the documents and a non-transitory memory device for storage of programming instructions, documents or portions of documents. Any suitable print device can be used including, but not limited to, inkjet and laser print devices, copiers, print devices, and the like. The print device may further include one or more sensors and/or monitors that collect information relating to a machine state of the print device. Examples of such sensors and/or monitors may include, without limitation, actuators, end switches, toner sensors, paper tray sensors, paper jam sensors, shaft rotation sensors, position sensors, ink sensors, acceleration and/or velocity sensors, tension sensors, torsion sensors, heating/cooling sensors, voltage sensors, current sensors, connectivity detectors, light sensors, time sensors, print setting sensors, or any other similar device that may collect data from individual components of a print drive, and send signals or input about the individual components to a processing device.

The term “multi-function device” (or “MFD”) refers to a print device comprising hardware and associated software configured for enabling the device to print documents on substrates, as well as perform at least one other function on a document such as copying, facsimile transmitting or receiving, image scanning, emailing, or performing other actions on document-based data.

The terms “computer-readable medium,” “data storage facility,” and “memory” each refer to a non-transitory device on which computer-readable data, programming instructions or both are stored. Unless the context specifically states that a single device is required or that multiple devices are required, the terms “computer-readable medium,” “data storage facility,” and “memory” include both the singular and plural embodiments, as well as portions of such devices such as memory sectors.

In this document, the terms “processor” and “processing device” refer to a hardware component of an electronic device that is configured to execute programming instructions. The term “processor” may refer to either a single processor or to multiple processors that together implement various steps of a process. Unless the context specifically states that a single processor is required or that multiple processors are required, the term “processor” includes both the singular and plural embodiments.

The term “machine state” of a print device refers to its state of operation at a given point of time. Examples of machine state may include, without limitation, SHUTDOWN ERROR STATE (e.g., system unable to print or process a current job due to fault condition), NEEDS ATTENTION STATE (e.g., attention needed soon to continue uninterrupted production), INFORMATIONAL (e.g., informational message exists), OPERATIONAL (e.g., system is printing a job, system is powering on, system is booting up, system is updating, system is downloading data, battery life, or the like), STEADY STATE (e.g., MFD turned off, no active print jobs in system or idle, or an MFD is powered “on” and ready for printing), or the like.

A machine state may have a “status” associated with it that may provide additional information about the machine state such as the percentage of completion (and/or remaining) of a function like printing, time associated with a fault, or the like. Other machine states and statuses are within the scope of this disclosure.

A “projected light pattern” is a visual signal that provides various real-time information relating to a machine state of an MFD, and which is provided using projection of light (or projected light) onto and/or proximate to an area of the MFD that relates to the machine state. The visual signal may include one or more projected light patterns obtained by varying one or more characteristics of the projected light such as, without limitation, size, color, intensity, shape, or the like. Examples of projected light patterns may include, without limitation, one or more light colors, a blinking light, an icon, text, and/or any other suitable light pattern.

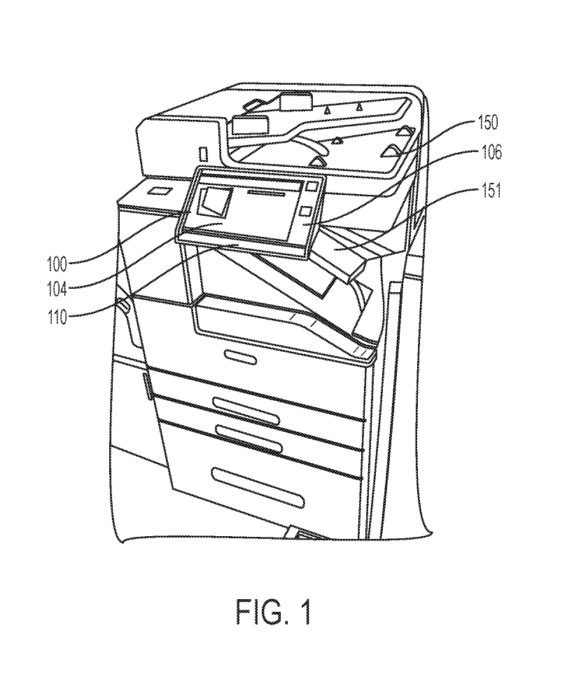

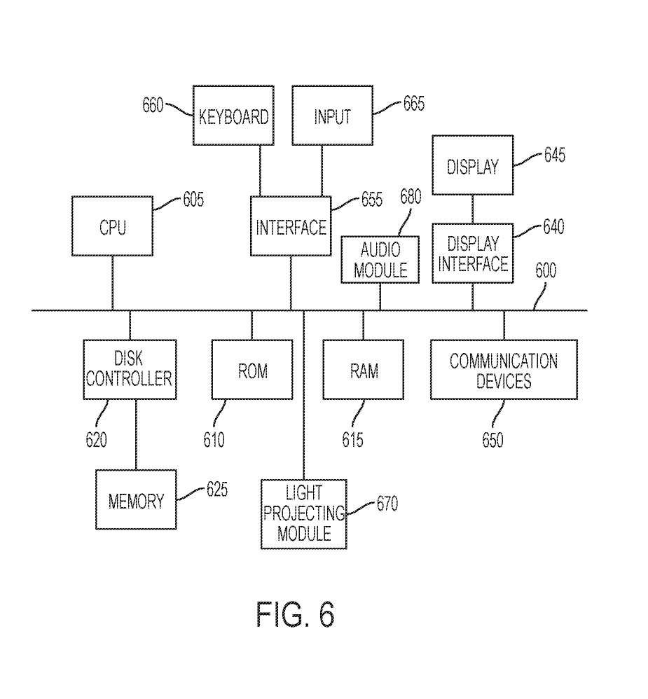

FIG. 1 shows an example system for conveying device status information by projecting light using a light projection unit 100 proximate to an MFD 150. As used herein “proximate” refers to, without limitation, attached to the MFD, or in the vicinity of the MFD such that the light projection unit may communicate with the MFD. In an embodiment, light projection unit 100 attached to an MFD 150, via an attachment interface 101. In another embodiment, the light projection unit 100 may be disposed near the MFD 150 and may communicate with the MFD 150 via a wired or wireless communications link (such as Bluetooth, Internet, or the like). Example internal configuration of an example system is shown in FIG. 6 below.

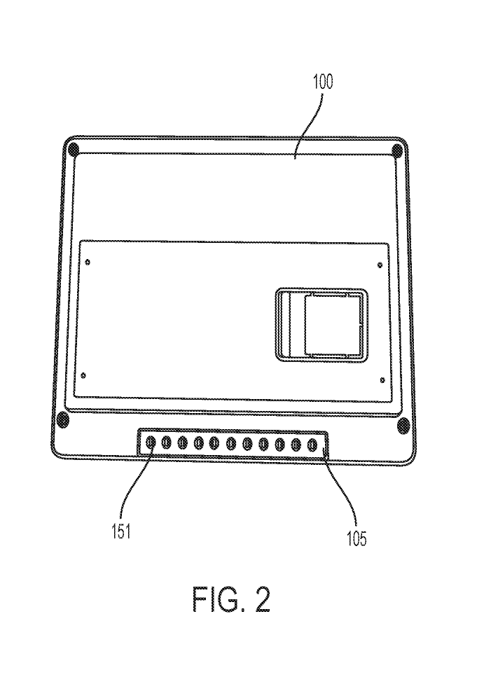

As shown in FIG. 1, the light projection unit 100 may include a light projecting module (shown and described with context of FIG. 2 below) configured to project light onto an area 151 of the MFD 150. In an embodiment, area 151 may be an output tray, an input tray, or another area of the MFD 150. The light projection unit of FIG. 2 may also include a display 104 for providing more information to a user, in addition to the projected light. For example, in an embodiment, the display 104 may provide detailed information about the projected light using text, graphics, and/or pictures. As shown in FIG. 2, the light projection unit 100 may also include one or more user interfaces 106 (a button, a touch screen, or the like). In an embodiment, the light projection unit 100 may also include a light emitting device 110 configured to emit light (that is not projected onto the MFD).

FIG. 2 illustrates the back view of the light projection unit 100. As shown in FIG. 2, the light projection unit includes a light projecting module 105 that includes one or more light emission devices 151 for projecting light from the back of the light projection unit 100 onto the MFD 150 (as shown in FIG. 1). The light projecting module 105 and its components are discussed below in detail in the context of FIG. 4.

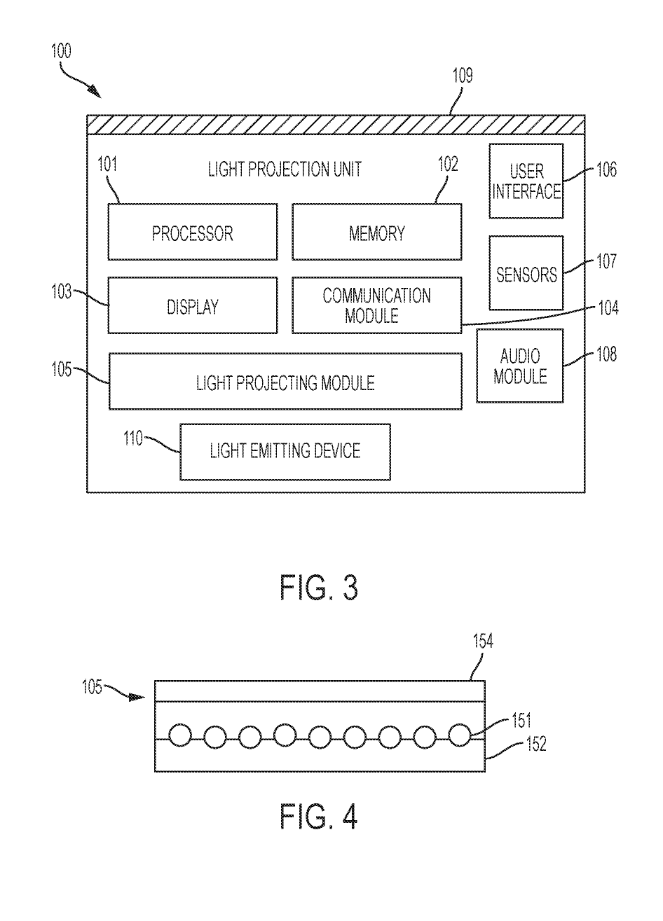

FIG. 3 is a block diagram that illustrates various elements of a light projection unit 100 that may be used to convey device status information using projected light as discussed below with respect to FIG. 3. In an embodiment, the light projection unit 100 is an electronic device that may include a processor 101 that is in electronic communication with other elements of the light projection unit. The light projection unit may include programming instructions that when executed cause the processor 101 to convey the machine state, and its corresponding status, of an MFD attached to the light projection unit, as discussed below, in conjunction with the light projecting module 105. The light projection unit 100 may also include a communication module 104 that is capable of transmitting and/or receiving data via one or more communication protocols to and/or from an MFD that is attached to or is integral with the light projection unit 100.

In an embodiment, the light projection unit 100 may also include a user interface 106 to transmit to and/or receive instructions from a user of the MFD. Example may include, without limitation, a keypad, a touchscreen, an audio interface, or the like. In some embodiments, the light projection unit 100 may also include a display 103 and an audio module 108 for providing device status information to a user, in addition to the projected light. In an embodiment, the audio module 108 may include, without limitation, a sound card, a sound chip, and other sound output circuitry that may outputs audio to a speaker, headphones, or the like (not shown). In an embodiment, the light projection unit 100 may include a light emitting device 110 configured to emit light (that is not projected onto the MFD) for providing device status information to a user, in addition to the projected light. In an embodiment, light emitting device 110 may include, without limitation, one or more light emission devices, optical components, a control unit, and other light output circuitry (not shown).

In an embodiment, the light projection unit 100 may include one or more light projecting modules 105. As shown in FIG. 4, a light projecting module 105 may include one or more light emission devices 151 (e.g., a light-emitting diode (LED), a light pipe, a bulb, a wide dispersion bulb, a digital light projector, a laser, and/or any other suitable light source) mounted on a substrate 152. The substrate 152 is a mounting substrate, and provides electrical conductors (not shown) and electrical circuits such as a printed circuit board (not shown) for electrically connecting the light emission devices 151. The substrate 152 can comprise silicon, or another semiconductor material such as GaAs, SiC, GaP, GaN or AlN. Alternately, the substrate 152 can comprise a ceramic material, sapphire, glass, a printed circuit board (PCB) material, a silicone submount substrate, or any packaging substrate used in the art.

In an embodiment, the light projecting module 105 may include one or more optical components 154 for processing and/or projecting the light emitted by a light emission device. Examples of optical components may include, without limitation, optical lens, optical panel(s), optical channels, prisms, reflective surfaces, or other structures that are capable of directing, converting, and splitting optical light. For example, in an embodiment, the light projecting module 105 may include one or more optical lenses for projecting light from the one or more a light emission devices. For example, an optical component may include a lens structure made from a suitable material such as, without limitation, silicone, glass, clear resin, epoxy, or the like. A lens may be a directional lens, a focusing lens, and/or any other suitable lens. In an embodiment, the lens structure may include a design configured to emit light according to a desired pattern (such as intensity, color, etc.). In an embodiment, the optical components may be configured (or designed) to project light in any desired pattern, angle, or direction for creating a projected light pattern (as discussed below).

The projected light may be any suitable shape, color, pattern, text, number, symbol, etc. of light that is visible to a user. The one or more light emission devices 151 in the light projecting module 105 may be arranged to provide projected light in the form of one or more geometrical shapes and/or patterns such as a line bar, a ring, a wave, interconnected shapes, or the like. Additionally and/or alternatively, an optical component 154 may be configured to project light in one or more geometrical shapes and/or patterns. In an embodiment, the one or more light emission devices may include light emission devices of different colors or groups of light emission devices comprising different colors (such as green, yellow, blue and red, among others) with each group comprising light emission devices of the same colors. In an embodiment, the light projecting module 105 may simultaneously project multiple colors. For example, the light projecting module 105 may include a red LED and a green LED may be mounted adjacent to one another behind optical component. When the red LED is activated and the green LED is turned off, red light will be projected. Green light will be projected when the red LED is off and the green LED is on. Amber light may be projected by simultaneously activating both the green and red LEDs. In an embodiment, the projected light can be a circle, a square, a dot, a rectangle, and/or any other visible shape to the user. For example, light projection module 105 may project a progress bar, text (such as error, printing, etc.), or the like on an area of the MFD.

In an embodiment, the light projection module 105 may project light in a plurality of directions, i.e., at a plurality of angles. For example, in an embodiment, the light projection module 105 may adjust the projection angle of an optical component 154 (such as by turning the optical component) to control the angle of the projected light. For example, the light projection nodule 105 may control a motor (by transmitting appropriate direction signals) that is configured to adjust the projection angle of an optical component 154. Alternatively and/or additionally, the light projection module 105 may control the angle of the projected light by turning on/off one or more of the light emission devices 151. In an embodiment, the light projection module 105 may control the direction and/or angle of projected light in order to project light on to and/or proximate to an area of the an MFD that corresponds to its machine state. For example, the light projection module 105 may project light on an output tray of an MFD to indicate print job completion and the output tray identification. Similarly, the light projection module 105 may project light on a paper input tray to indicate machine states such as “need more paper,” “a paper jam,” or “appropriate paper size,” or the like. In another embodiment, the light projection module 105 may project light towards a toner cartridge of an MFD to indicate machine states such as “toner running low,” or the like.

The light projecting module 105 may include a control unit (not shown) in communication with the processor 101, for generating various control signals that affect the emission of light through the one or more light emission devices. The processor 101 may send and/or receive control signal to and/or from the control unit via one or more protocols (such as I²C, PWM, analog, digital, or the like).

In one embodiment, the control unit may adjust the brightness, color, pattern, timing, and on/off of the one or more light emission devices (such as LEDs) to create a projected light pattern corresponding to a current machine state of an MFD. In an embodiment, the control unit may include ports connecting to one or more LEDs. The control unit may change the duty cycle of pulse width modulation (PWM) to adjust the brightness and on/off of each LED in the light projecting module 105. In PWM, a high-frequency signal (e.g., a square wave signal at 100 kHz) has its pulse width adjusted up or down to control the amount of power being drawn by an LED. The duty cycle is a ratio between the pulse width and the pulse period, and is represented as a percentage. Duty cycle of a PWM signal determines the average LED current flow. As the duty cycle is increased, the pulse width becomes wider while the period remains the same and an LED gets brighter. Additionally and/or optionally, LED control unit may regulate the amount of current supplied to each of the LEDs where the intensity of the light emitted by an LED on the amount of current supplied to the LED. In an embodiment, the control unit may also adjust the color of a status indicator feedback by turning on/off LEDs of one or more colors. Other now or hereafter known regulation methods are within the scope of this disclosure.

In one embodiment, the light projection unit 100 may include one or more sensors 107 such as a proximity sensor, a motion sensor, an audio sensor, a mobile device detector, a biometric sensor, a radio frequency identification (RFID) tag for authenticating a user, or the like. In an embodiment, light projection unit 100 may only provide a projected light pattern in response to a sensor detecting a user in the vicinity of an MFD.

In an embodiment, the light projection unit 100 may include a light sensor to detect an intensity of ambient light in an area where light is to be projected. The light projection unit 100 may adjust the intensity of projected light based on the ambient light. For example a low power light may be projected if the ambient light is low. Alternatively, a high power light may be projected if the ambient light is high.

The light projecting module 105 may also include other components such as a heat sink, a power supply, or the like (not shown here).

In an embodiment, the light projection unit 100 also includes a computer-readable medium containing programming instructions that, when executed, cause the processor 101, and/or other processing devices to: (i) receive information relating to a machine state and its corresponding status of an MFD from one or more sensors; (ii) analyze the received information to determine a machine state and its corresponding status of the MFD; and/or (ii) provide MFD status information to a user using projected light. The computer-readable medium may be a memory unit 102 of the light projection unit 100, a memory unit of an MFD (not shown here), a memory unit of the light projecting module, or a memory of another device such as a remote system that is in communication with the MFD and/or the light projection unit 100.

In an embodiment, to receive a machine state and other status information of an MFD, the light projection unit 100 may also include an attachment interface 109 configured to attach to a corresponding counterpart of the MFD, an MFD, or the like. The attachment interface may allow the light projection unit 100 to electronically and/or physically connect to an MFD for sending and/or receiving information to and/or from the attached MFD. An attachment interface 109 may include, without limitation, a wired connection (such as a cable), one or more connection ports (such as a data port), a docking station, or the like. Alternatively and/or additionally, the light projection unit 100 may communicate with the MFD using wireless communications protocols such as Bluetooth, Wi-Fi, Zigbee, or the like.

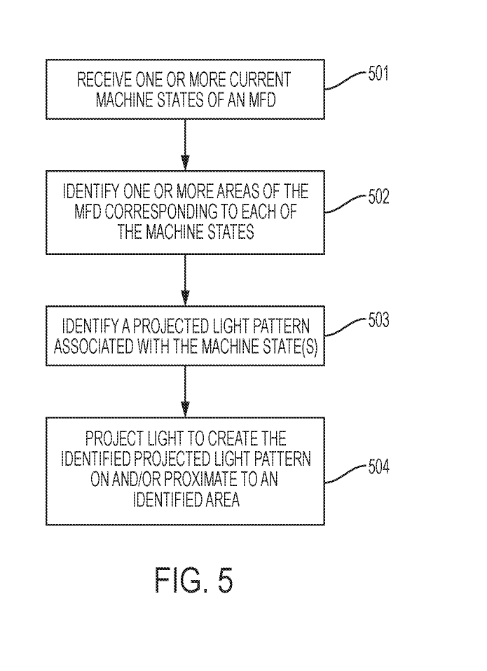

A method for conveying device status information using projected light is further described in detail with reference to FIG. 5. The light projection unit may receive 501 one or more current machine states, and their corresponding statuses, for an MFD. In an embodiment, one or more sensors of an MFD may continuously transmit data relating one or more electronic components of the MFD to a processor of the MFD, which may use the data to determine a current machine state, and its corresponding status, before transmitting it to the light projection unit. In an alternate embodiment, the light projection unit may receive information relating to one or more current machine states and their corresponding statuses (such as data relating one or more electronic components of the MFD from the one or more sensors and/or a processor of the MFD) of an MFD, and process the received information to determine the current machine state, and its corresponding status, of the MFD.

Alternatively and/or additionally, the light projection unit may receive information relating to current machine state(s), and its corresponding status, of an MFD at fixed time intervals, upon user request, and/or upon occurrence of certain events. Examples of such events may include, without limitation, change in a machine state of an MFD, change in a status of the machine state of an MFD, resolving of a fault or error of an MFD, detection of a user in proximity of an MFD (using a proximity sensor), or the like. The information may include, without limitation, the current machine state such as on, off, idle, powering on, powering off, printing, authenticating user, receiving data, printing, various faults such as low toner, no paper, or the like, and corresponding status information for the machine states.

As discussed above, examples of machine states may include, shutdown error state, needs attention state, operational state, steady state, or the like, and status provides additional information about a particular machine state. In an embodiment, machine states that require immediate user intervention because it has caused the system to be unable to produce the intended output or perform the intended function are “shutdown error” states. Examples may include, without limitation, a mis-feed jam (when an original an original has not been successfully fed through a document feeder), a paper jam, out of toner that is required for a current job, out of staples that is required for a current job, out of paper in a tray that is feeding a current job, MFD cannot download data, or the like. In an embodiment, machine states that indicate that a fault has occurred with respect to an MFD resource(s), but based on the system state and job request, the resource(s) is not immediately required are “needs attention” states. Examples may include, without limitation, out of toner that is not required for a current job, out of staples that is not required for a current job, out of paper in a tray that is not feeding a current job, low paper for a current job, low staples for a current job MFD cannot download data for a future job, firmware updates, or the like. In an embodiment, machine states that indicate a current ongoing function of an MFD are called “operational” states. Examples may include, printing, faxing, powering on, powering off, updating, transitioning to (or recovering from) power saving mode, authenticating a user, processing a print job, or the like. In an embodiment, machine states that indicate a normal/ready state of an MFD (i.e., when not performing a function) are called “steady” states. Examples may include, on, off, idle, function (like printing, etc.) completed, or the like.

A status comprising more information about a machine state may be associated with one or all of the machine states discussed above. For example, status of a machine state may include an indication of the type of machine state (such as shutdown error, needs immediate attention, operational, or steady state), an identification of the particular machine state (such as no paper, no toner, printing, powering on, etc.), and other information such as identification of a paper tray with no paper, identification of a toner, progress of printing, or the like.

The above discussed machine states, examples, and status, are provided by way of example only and other states are within the scope of this disclosure.

In an embodiment, the light projection unit may identify 502 one or more areas of the MFD corresponding to each of the machine states. An area of an MFD corresponding to a machine state refers to an area that is related to the machine state and/or provides information relevant to a machine state and/or status (such as location of a fault, output, etc.). For example, an output tray (such as print out tray, scan output tray, or the like) of an MFD corresponds to machine state “processing a print job”; a paper input tray of an MFD corresponds to machine states like “paper jam,” “out of paper,” “mis-feed jam” or the like; an toner cartridge of an MFD corresponds to machine states like “low toner.” Other area corresponding to one or more machine states of an MFD are within the scope of this disclosure.

In an embodiment, if a machine state does not have a corresponding area on an MFD (such as cannot download data, powering on, idle, or the like), the light projection unit may identify an area of the MFD to project light based on one or more rules. Example rules may include, without limitation, selecting an area with maximum visibility from a large distance and/or viewing angle (such as an output tray), an area that provides a good color contrast for the projected light (such as a white background), an area that does not adversely affect the brightness of projected light, or the like.

The light projection unit may also identify 503 a projected light pattern associated with the identified machine state(s). A projected light pattern refers to a visual light pattern created by projecting light, on an area of an MFD, in a particular sequence or arrangement that provides, to a user, relevant information about one or more machine states of the MFD. One or more characteristics of the projected light pattern may be changed in real-time to provide information about a status(es) of the one or more machine states. A projected light pattern may include patterns formed be varying one or more characteristics of the projected light, such as without limitation, color, intensity, size, and/or a combination thereof. In an embodiment, the projected light pattern is automatically updated in real-time if a machine state and/or its corresponding status changes.

In an embodiment, a projected light pattern may convey information to a user using one or more colors of light such as monochromatic lights or lights that can be adjusted to produce two, three, or more than three colors. For example, a red color may be used to indicate machine states in the shutdown error state category, an amber color may be used to indicate machine states in the needs attention state category, a green color may be used to indicate machine states in the operational state category, and a blue color may be used to indicate machine states in the steady state category. One or more colors may also be used to distinguish between machine states in the same category. In some embodiments, more than one color in a projected light pattern may be used to convey information about one or more machine states.

In another example of a projected light pattern may convey information to a user using intensity (or brightness) variations. For example, the light projection unit may create a projected light pattern by increasing the intensity of projected light based on the increase (or decrease) in time an MFD is in a machine state in the shutdown error state and/or a needs attention state. In another example, the light projection unit may create a projected light pattern by increasing (or decreasing) the intensity of projected light as the time for processing a job associated with a machine state in the needs attention state category approaches. In yet another example, the light projection unit may create a projected light pattern by decreasing (or increasing) the intensity of projected light based on the increase in time an MFD is in a machine state corresponding to a steady state category. In another example, the light projection unit may create a projected light pattern by increasing the intensity of projected light based on the increase (or decrease) in percentage of completion of an operation in a machine state corresponding to the operational state category.

In another embodiment, a projected light pattern may convey information to a user using other illumination patterns such as solid or steady, blinking, blinking with different patterns and/or rates, or the like, that may also be created by varying the intensity of projected light. For example, a solid light may be used to convey information about a machine state in the steady state and/or operational category and/or a blinking light may be used to convey information about a machine state in the shutdown error state and/or the needs attention state category. In an embodiment, the light projection unit may create a projected light pattern by increasing the rate of blinking of light based on the increase (or decrease) in time an MFD is in a machine state in the shutdown error state and/or a needs attention state. In another example, a the light projection unit may create a projected light pattern by increasing (or decreasing) the rate of blinking as the time for processing a job associated with a machine state in the needs attention state category approaches.

In yet another example, a projected light pattern may convey information to a user by projecting light in different shapes and/or sizes (for e.g., by selective illumination of LEDs). Examples of shapes may include, without limitation a bar shape, a ring shape, a circle, a wave, a dot, and/or a combination thereof. Different shapes may be associated with different machine states. In an embodiment, the light projection unit may create a projected light pattern by increasing (or decreasing) the size of projected light as the time for processing a job associated with a machine state in the needs attention state category approaches, and/or based on the increase (or decrease) in percentage of completion of an operation in a machine state corresponding to the operational state category.

In an embodiment, one or more of the above projected light patterns such as color variations, intensity variations, illumination patterns, shape variations, and/or size variations may be combined to convey information about a machine state(s), and its corresponding status, of an MFD. For example, a red color may be used to indicate a machine state corresponding to a shutdown error state and its corresponding status (such as time) may be indicated using a blinking pattern with change in rate of blinking. Similarly, a green color may be used to indicate a machine state corresponding to an operational state, and growing ring and/or bar shape may be used to indicate corresponding status (such as percentage of completion). In one example, a currently printing machine state may be shown using a rectangle and the size of the rectangle may be increased based on the percentage of completion.

It should be noted that the above projected light patterns and examples are provided by way of example only and various other patterns may be used without deviating from the principles of this disclosure. Similarly, the above discussed projected light pattern examples may be used to convey information about other machine states. In an embodiment, a user may provide some or all of rules for identifying and/or creating the projected light patterns and the associated machine state.

In an embodiment, the light projection unit may project light 504 to create the identified projected light pattern corresponding to an identified machine state, on and/or proximate to an area identified as corresponding to the machine state. As discussed above, the light projection unit may include a control unit that may adjust the brightness, color, timing, intensity, and on/off of the one or more light emission devices to create the projected light pattern. As is known to those skilled in the art, luminance of the light emission device is a function of the average current flow through the light emission device. In an embodiment, the control unit may use one or more of any now or hereafter known protocols (such as PWM, I²C, etc.) to create the projected light pattern (discussed above). For example, in an embodiment, the control unit may generate illumination signals to the one or more light emission devices, such that the illumination signals depend upon the projected light pattern. For example, an illumination signal delivered to an light emission device may include information relating to drive current, voltage, color, frequency, intensity, etc. for illumination of that particular light emission device.

Alternatively and/or additionally, an optical component of the light projection unit may adjust the brightness, color, intensity, focus, and/or directionality, of the one or more light emission devices to create the projected light pattern.

In an embodiment, the light projection unit may project light on a print output tray of an MFD, in an identified projected light pattern, to convey information relating to a print job being delivered to the output tray. Examples of such information may include, without limitation, percentage of completion (by creating a growing shape, text, symbols, or the like using projected light), print job completion, the output tray identification, or the like. In another embodiment, the light projection unit may project light on a paper input tray of an MFD, in an identified projected light pattern, to convey information relating to a document processing job for which paper is being fed by the input tray. Examples of such information may include, without limitation, percentage of completion (by creating a growing shape, text, symbols, or the like using projected light), need more paper, the input tray identification, a paper jam, a mis-feed jam, inappropriate paper size, or the like. In yet another embodiment, the light projection unit may project light on ink cartridge and/or a toner cartridge of an MFD, in an identified projected light pattern, to convey information relating to a document processing job. Examples of such information may include, without limitation, toner running low, ink running low, color printing, or the like.

In an embodiment, the light projection unit may simultaneously project light in one or more areas of an MFD to create one or more projected light patterns corresponding to one or more current machine states.

In an embodiment, the system may dynamically update and/or adjust the projected light based upon information received from one or more sensors of the MFD. For example, during printing of a print job, the system may continuously receive information about the status of one or more components of the MFD and use the information to determine a percentage of completion of the print job and/or time remaining till completion. The system may then update and/or adjust the projected light pattern for providing information relating to the percentage of completion of the print job and/or time remaining till completion in real time. In another example, the system may receive information from sensors such as the toner sensor, paper sensor, etc. to continuously determine if a change in a machine state, and its corresponding status, corresponding to the sensor (such as toner cartridge replaced, paper added, toner running low for next print job, or the like). The system may then update and/or adjust the projected light pattern such that it indicates the machine state, and its corresponding status, in real time.

FIG. 6 depicts an example of internal hardware that may be included in any of the electronic components of the system, the light projection unit, the MFD, or another device in the system. An electrical bus 600 serves as an information highway interconnecting the other illustrated components of the hardware. Processor 605 is a central processing device of the system, configured to perform calculations and logic operations required to execute programming instructions. As used in this document and in the claims, the terms “processor” and “processing device” may refer to a single processor or any number of processors in a set of processors Read only memory (ROM) 610 and random access memory (RAM) 615 constitute examples of memory devices or processor-readable storage media.

A controller 620 interfaces with one or more optional tangible, computer-readable memory devices 625 to the system bus 600. These memory devices 625 may include, for example, an external or internal disk drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 610 and/or the RAM 615. Optionally, the program instructions may be stored on a tangible computer readable medium 625 such as a compact disk, a digital disk, flash memory, a memory card, a USB drive, an optical disc storage medium, such as a Blu-ray™ disc, and/or other recording medium controlled via a disk controller 620.

An optional display interface 640 may permit information from the bus 600 to be displayed on a display device 645 in visual, graphic or alphanumeric format. A light projecting module 670 may include one or more LEDs and associated circuitry for generating various light effects by affecting the emission of light through the LED. An audio interface and audio output (such as a speaker) also may be provided. An audio interface and audio output (such as a speaker) also may be provided. An audio module 680 may include a sound card, a sound chip, and other sound output circuitry that outputs audio to a speaker, headphones, or the like.

Communication with external devices such, as a printing device, may occur using various communication devices 650 such as a transmitter and/or receiver, antenna, an RFID tag and/or short-range or near-field communication circuitry. A communication device 650 may be attached to a communications network, such as the Internet, a local area network or a cellular telephone data network.

The hardware may also include a user interface 655 that allows for receipt of data from input devices 660 such as a keyboard, a mouse, a joystick, a touchscreen, a remote control, a pointing device, a video input device (camera) and/or an audio input device (microphone). Various sensors (not shown here) such as a proximity sensor, may be included to detect user proximity. Other example sensors that may be used to detect user proximity may include, without limitation, a biometric sensor, an embedded sensor, user authentication modules such as a mag strip, a chip, an RFID tag, or the like.

The above-disclosed features and functions, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

What is claimed is:

1. A system for providing multifunction device (MFD) status information to a user, comprising:
an MFD comprising a print engine and one or more status monitors; and
a light projection unit, wherein the light projection unit comprises:
a light projecting module,
a processor in communication with the light projecting module; and
a computer-readable medium containing programming instructions that are configured to, when executed by the processor, cause the processor to:
receive information corresponding to a current machine state of the MFD from the one or more status monitors of the MFD,
identify an area of the MFD that corresponds to the current machine state,
identify a projected light pattern associated with the current machine state, wherein the projected light pattern comprises a visual pattern created using projected light,
instruct the light projecting module to project the identified projected light pattern proximate to the identified area of the MFD.

2. The system of claim 1, wherein the light projecting module comprises:
one or more light emission devices;
an optical component;
a control unit, wherein the control unit is configured to:
receive the projected light pattern associated with the identified machine state from the processor, and
generate commands to cause the one or more light emission devices to emit the visual pattern.

3. The system of claim 2, wherein the programming instructions that are configured to cause the processor to instruct the light projecting module to project the identified projected light pattern in the identified area of the MFD comprise programming instructions that are configured to cause the processor to adjust a direction of projection of the light projecting module using one or more of the following:
turning the optical component; or
turning one or more of the light emission devices on or off.

4. The system of claim 2, wherein the optical component comprises one or more of the following:
an optical lens;
an optical panel;
an optical channel;
a prism; or
a reflective surface.

5. The system of claim 1, wherein:
a characteristic of the visual pattern dynamically changes to convey real-time information about the status of the identified machine state; and
the characteristic comprises one or more of from the following: a size of the visual pattern, a shape of the visual pattern, an intensity of the visual pattern, or a brightness of the visual pattern.

6. The system of claim 1, wherein the programming instructions that are configured to cause the processor to receive the information corresponding to the current machine state from the MFD comprise programming instructions that are configured to cause the processor to receive the information:
continuously;
at fixed time intervals;
in response to a change in a machine state of the MFD; or
in response to a request sent from the light projection unit to the MFD.

7. The system of claim 1, wherein the programming instructions that are configured to cause the processor to identify the area of the MFD that corresponds to the current machine state comprise programming instructions that are configured to identify the area that provides information relating to the current machine state.

8. The system of claim 7, wherein the identified area comprises one or more of the following: a document processing job output tray; a document processing job input tray; or an ink cartridge.

9. The system of claim 1, wherein the projected light pattern comprises one or more of the following:
a blinking light pattern;
a solid light pattern in one or more light colors;
a growing bar shape light pattern;
a growing ring shape light pattern;
a pattern created by varying an intensity of projected light;
text; or
symbols.

10. The system of claim 1, wherein:
the current machine state corresponds to an output of a document processing job;
the identified area is an output tray of the MFD; and
the identified projected light pattern conveys information regarding one or more of the following:
an identification of the output tray to which the output of the document processing job will be delivered,
a status of the document processing job, or
completion of the document processing job.

11. The system of claim 1, wherein:
the current machine state corresponds to an input of a document processing job;
the identified area is an input tray of the MFD; and
the identified projected light pattern conveys information regarding one or more of the following:
an identification of the input tray from which paper is fed for the document processing job,
needs more paper,
a paper jam, or
or a mis-feed jam.

12. A system for providing multifunction device (MFD) status information to a user, comprising:
receiving, by a processing device, information corresponding to a current machine state of an MFD from one or more status monitors of the MFD;
identifying, by the processing device, an area of the MFD that corresponds to the current machine state;
identifying, by the processing device, a projected light pattern associated with the current machine state, wherein the projected light pattern comprises a visual pattern created using projected light;
instructing, by the processing device, a light projecting module to project the identified projected light pattern proximate to the identified area of the MFD.

13. The method of claim 12, wherein:
the light projection unit comprises:
one or more light emission devices,
an optical component, and
a control unit; and
instructing, by the processing device, the light projecting module to project the identified projected light pattern proximate to the identified area of the MFD comprises, by the control unit:
receiving the projected light pattern associated with the identified machine state from the processor, and
generating commands to cause the one or more light emission devices to emit the visual pattern.

14. The method of claim 13, wherein instructing the light projecting module to project the identified projected light pattern in the identified area of the MFD comprises adjusting a direction of projection of the light projecting module using one or more of the following:
turning the optical component; or
turning one or more of the light emission devices on or off.

15. The method of claim 13, wherein the optical component comprises one or more of the following:
an optical lens;
an optical panel;
an optical channel;
a prism; or
a reflective surface.

16. The method of claim 12, wherein:
a characteristic of the visual pattern dynamically changes to convey real-time information about the status of the identified machine state; and
the characteristic comprises one or more of from the following: a size of the visual pattern, a shape of the visual pattern, an intensity of the visual pattern, or a brightness of the visual pattern.

17. The method of claim 12, receiving the information corresponding to the current machine state from the MFD comprises receive the information:
continuously;
at fixed time intervals;
in response to a change in a machine state of the MFD; or
in response to a request sent from the light projection unit to the MFD.

18. The method of claim 12, wherein identifying the area of the MFD that corresponds to the current machine state comprises identifying the area that provides information relating to the current machine state.

19. The method of claim 18, wherein the identified area comprises one or more of the following: a document processing job output tray; a document processing job input tray; or an ink cartridge.

20. The method of claim 12, wherein the projected light pattern comprises one or more of the following:
a blinking light pattern;
a solid light pattern in one or more light colors;
a growing bar shape light pattern;
a growing ring shape light pattern;
a pattern created by varying an intensity of projected light;
text; or
symbols.

21. The method of claim 12, wherein:
the current machine state corresponds to an output of a document processing job;
the identified area is an output tray of the MFD; and
the identified projected light pattern conveys information regarding one or more of the following:
an identification of the output tray to which the output of the document processing job will be delivered,
a status of the document processing job, or
completion of the document processing job.

22. The method of claim 12, wherein:
the current machine state corresponds to an input of a document processing job;
the identified area is an input tray of the MFD; and
the identified projected light pattern conveys information regarding one or more of the following:
an identification of the input tray from which paper is fed for the document processing job,
needs more paper,
a paper jam, or
or a mis-feed jam.
